(19) United States
(12) Patent Application Publication
(10) Pub. No.: US 2026/0120341 A1
(43) Pub. Date: Apr. 30, 2026

(54) IMAGE GENERATION

(71) Applicant: Beijing Zitiao Network Technology Co., Ltd., Beijing (CN)

(72) Inventors: Xin Xia, Beijing (CN); Xuefeng Xiao, Beijing (CN)

(21) Appl. No.: 19/372,002

(22) Filed: Oct. 28, 2025

(30) Foreign Application Priority Data
Oct. 28, 2024 (CN) 202411514127.5

(51) Int. Cl. G06T 11/00; G06N 20/00

(52) U.S. Cl. CPC G06T 11/00; G06N 20/00

(57) ABSTRACT

A method, an apparatus, a device, and a medium for image generation are provided. In one method, a diffusion model is obtained, the diffusion model is an image generation model and describes an association relationship between a prompt and an image generated based on the prompt. Based on a predetermined division parameter, a plurality of steps associated with the diffusion model is divided into a first set of steps and a second set of steps. Based on a current step of the diffusion model, the first set of steps, and the second set of steps, a guidance parameter for distilling the diffusion model into a target model is determined, the guidance parameter represents an association relationship between a prompt and an image associated with the diffusion model. The diffusion model is distilled into the target model based on the guidance parameter.

### CROSS-REFERENCE

This application claims the benefit of Chinese Patent Application No. 202411514127.5, filed on Oct. 28, 2024, entitled “METHOD, APPARATUS, DEVICE AND MEDIUM FOR IMAGE GENERATION”, the entirety of which is incorporated herein by reference.

### FIELD

Implementations of the present disclosure generally relate to image generation, and more particularly to image generation.

### BACKGROUND

Machine learning techniques have been widely used to perform image generation tasks. For example, it has been proposed to use a diffusion model to generate an image that matches a prompt. The inference stage of the diffusion model involves a large number of denoising steps, which results in an excessive workload for the model. Although certain technical solutions may convert a complex diffusion model to a simpler model, the capabilities of the converted model are not satisfactory, and may lead to a degradation of the functionalities of the model, for example, not supporting certain debugging operations, and the like. At this point, it is expected that the performance of the diffusion model can be improved while ensuring the functionality of the diffusion model.

### SUMMARY

In a first aspect of the present disclosure, a method for image generation is provided. In the method, a diffusion model is obtained, the diffusion model is an image generation model and describes an association relationship between a prompt and an image generated based on the prompt. A plurality of steps associated with the diffusion model is divided into a first set of steps and a second set of steps based on a predetermined division parameter. Based on a current step of the diffusion model, the first set of steps, and the second set of steps, a guidance parameter for distilling the diffusion model into a target model is determined. The guidance parameter represents an association relationship between a prompt and an image associated with the diffusion model. The diffusion model is distilled into the target model based on the guidance parameter.

In a second aspect of the present disclosure, an apparatus for image generation is provided. The apparatus includes: an obtaining module configured to obtain a diffusion model, the diffusion model being an image generation model and describing an association relationship between a prompt and an image generated based on the prompt; a division module configured divide, based on a predetermined division parameter, a plurality of steps associated with the diffusion model into a first set of steps and a second set of steps; a parameter determination module configured to determine, based on a current step of the diffusion model, the first set of steps, and the second set of steps, a guidance parameter for distilling the diffusion model into a target model, the guidance parameter representing an association relationship between a prompt and an image associated with the diffusion model; and a distillation module configured to distill the diffusion model into the target model based on the guidance parameter.

In a third aspect of the present disclosure, an electronic device is provided. The electronic device includes: at least one processor; and at least one memory coupled to the at least one processor and storing instructions for execution by the at least one processor, and the instructions, when executed by the at least one processor, cause the electronic device to perform the method of the first aspect of the present disclosure.

In a fourth aspect of the present disclosure, a computer-readable storage medium is provided. The computer-readable storage medium have a computer program stored thereon, and the computer program, when executed by a processor, causes the processor to implement the method of the first aspect of the present disclosure.

In a fifth aspect of the present disclosure, a computer program product is provided. The computer program product includes a computer program, and the computer program, when executed by a processor, implements the method of the first aspect of the present disclosure.

It should be understood that the content described in this Summary section is not intended to limit the key features or critical features of the implementations of the present disclosure, nor is it intended to limit the scope of the present disclosure. Other features of the present disclosure will be readily understood from the following description.

### BRIEF DESCRIPTION OF DRAWINGS

In the following, the above and other features, advantages, and aspects of various implementations of the present disclosure will become more apparent from the following detailed description taken in connection with the accompanying drawings. In the drawings, the same or similar reference signs refer to the same or similar elements, where:

FIG. 1 illustrates a block diagram of an application environment according to an implementation of the present disclosure;

FIG. 2 illustrates a block diagram for image generation according to some implementations of the present disclosure;

FIG. 3A illustrates a block diagram for generating a fusion model according to some implementations of the present disclosure;

FIG. 3B illustrates a block diagram for generating a fusion model according to some implementations of the present disclosure;

FIG. 4 illustrates a block diagram of guidance parameters according to some implementations of the present disclosure;

FIG. 5 illustrates a flowchart of a method for image generation according to some implementations of the present disclosure;

FIG. 6 illustrates a block diagram of an apparatus for image generation according to some implementations of the present disclosure; and

FIG. 7 illustrates a block diagram of a device capable of implementing various implementations of the present disclosure.

### DETAILED DESCRIPTION

Implementations of the present disclosure will be described in more detail below with reference to the accompanying drawings. While certain implementations of the present disclosure are shown in the accompanying drawings, it should be understood that the present disclosure may be implemented in various forms and should not be construed as being limited to the implementations set forth herein, but rather, these implementations are provided for a more thorough and complete understanding of the present disclosure. It should be understood that the drawings and implementations of the present disclosure are given for illustrative purposes only and are not intended to limit the scope of the present disclosure.

In the description of the implementations of the present disclosure, the term “comprising/including” and its equivalents should be construed as being open-ended inclusive, i.e., “including, but not limited to”. The term “based on” should be construed as “based at least in part on”. The terms “one implementation” or “the implementation” should be construed as “at least one implementation”. The term “some implementations” should be construed as “at least some implementations”. Other definitions, either explicit or implicit, may also be included below. As used herein, the term “model” may represent an association relationship between various data. For example, the above association relationship may be acquired based on various technical solutions that are currently known and/or will be developed in the future.

It should be understood that the data involved in the technical solution (including but not limited to the data itself, the acquisition or use of the data) should comply with the requirements of the corresponding laws and regulations and related provisions.

It should be understood that before using the technical solutions disclosed in the implementations of the present disclosure, the user should be informed of the types, use ranges, use scenarios, and the like of the personal information related to the present disclosure in an appropriate manner according to relevant laws and regulations and acquire the user's authorization.

For example, in response to receiving an active request from a user, prompt information is sent to the user to explicitly prompt the user that the requested operations to be performed would require acquisition and use of personal information of the user. Thus, the user can autonomously select whether to provide personal information to software or hardware such as an electronic device, an application, a server, or a storage medium that performs the operations of the technical solution of the present disclosure, according to the prompt information.

As an optional but non-limiting implementation, in response to receiving an active request from a user, the prompt information may be sent to the user, for example, in the form of a pop-up window in which the prompt information is presented in the form of text. In addition, the pop-up window may further carry a selection control for the user to select “agree” or “disagree” to provide personal information to the electronic device.

It should be understood that the above process for notifying and acquiring user authorization is merely illustrative, and does not limit the implementations of the present disclosure, and other manners that satisfy related laws and regulations may also be applied to the implementations of the present disclosure.

The term “in response to” as used herein indicates a state in which a respective event occurs or a condition is satisfied. It will be appreciated that there may not be a strong correlation between the timing of execution of a subsequent action that is performed in response to the event or condition and the time when the event occurs or the condition is established. For example, in some cases, a subsequent action may be performed immediately when an event occurs or a condition is established; while in other cases, the subsequent action may be performed after a period of time elapses after the event occurs or the condition is established.

### Example Environment

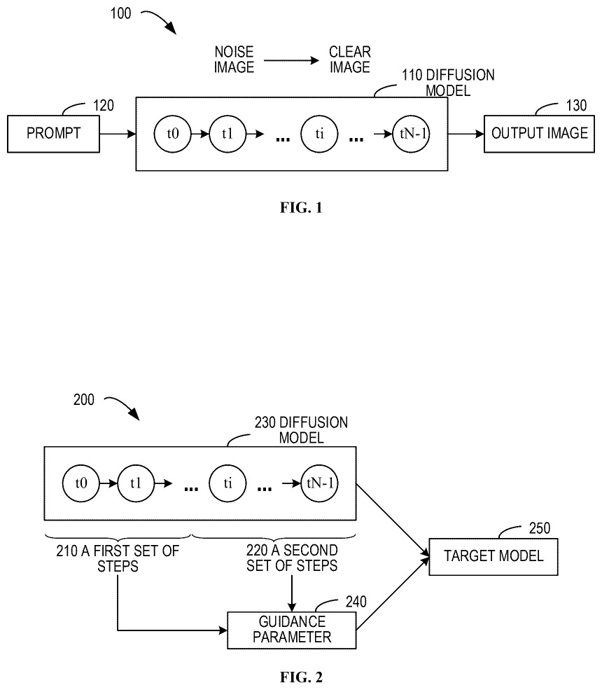

Machine learning techniques have been widely used to perform image generation tasks. For example, it has been proposed to use a diffusion model to generate an image that corresponds to a prompt. The inference stage of the diffusion model involves a large number of denoising steps, which results in unsatisfactory performance of the model. Referring to FIG. 1, which depicts an application environment according to some implementations of the present disclosure, FIG. 1 illustrates a block diagram 100 of the application environment according to an implementation of the present disclosure. As shown in FIG. 1, a diffusion model 110 may be obtained, and the diffusion model may include a plurality of steps (e.g., N steps, corresponding to a plurality of time instants t₀, t₁, . . . , tᵢ, . . . , t_{N-1}, respectively). During the execution of the plurality of steps, the noise image including more noise may be converted into a clear image step by step based on a prompt 120, and finally an output image 130 is obtained.

In order to support unconditional image generation, the diffusion model may support a Classifier-Free Guidance (CFG) strategy. And at this point, two separate inferences (conditional inference and unconditional inference) need to be performed at each step. This leads to a doubling of the number of inference steps of the diffusion model, which results in an increased workload and performance degradation. Although the knowledge distillation technique may convert a complex diffusion model into a simpler model, the performance of the converted model is not satisfactory, and may lead to a degradation of the model's functionalities, for example, not adjusting the scale parameter of the CFG, failing to debug a negative prompt, and so on. Therefore, it is expected that the performance of the diffusion model can be improved while ensuring the performance and functionality of the diffusion model.

### Overview of Image Generation

In order to at least partially solve the deficiencies in the related art, according to an implementation of the present disclosure, a method for image generation is provided. In summary, in the context of the present disclosure, the number of the additional inference related to CFG may be reduced, thereby achieving an acceleration of the inference process. The overview of one implementation according to the present disclosure is described with reference to FIG. 2, which illustrates a block diagram 200 for image generation according to some implementations of the present disclosure. As shown in FIG. 2, a diffusion model 230 may be obtained, and the diffusion model 230 is an image generation model and describes an association relationship between a prompt and an image generated based on the prompt. In other words, a prompt may be inputted to the diffusion model 230, and the diffusion model 230 may output an output image generated based on the prompt. Here, the diffusion model 230 may support unconditional inference, that is, the inputted prompt may be null; the diffusion model 230 may further support conditional inference, and in this case, the inputted prompt is represented in a natural language and is non-null. For example, the prompt may instruct the diffusion model 110 to generate a certain object, for example, “a cup of coffee”, “a cat”, and so on.

Based on a predetermined division parameter, a plurality of steps associated with the diffusion model may be divided into a first set of steps and a second set of steps. Here, the plurality of steps may include N steps for denoising step by step, and the first sets of steps and second sets of steps may be determined in the order of the steps. For example, the first set of steps may include step 0 to step k_{T′}−1 (corresponding to time instants t₀−(T′−1), respectively), and the second set of steps may include step k_{T′} to step N−1 (corresponding to time instants T′−t_{N-1}, respectively). Further, a guidance parameter 240 for distilling the diffusion model into a target model may be determined based on a current step (i.e., corresponding to time instant t) of the diffusion model, the first set of steps, and the second set of steps, and the guidance parameter represents an association relationship between a prompt and an image associated with the diffusion model. Further, the diffusion model may be distilled into the target model 250 based on the guidance parameter.

In the context of the present disclosure, CFG is a technical solution for improving the quality of the generated result of the diffusion model. The core idea of CFG is to make the generated image more consistent with a given condition (for example, text description in the prompt represented by the natural language) by controlling the guidance strength in the generation process without relying on an explicit classifier. In CFG, the guidance scale parameter is a key indicator for controlling the association relationship between the generation result and the prompt. Specifically, the value range of the guidance scale parameter is usually greater than 1, for enabling the CFG. The larger the value is, the higher the association between the generated image and the prompt is, but a certain degree of naturality and reality may be sacrificed. The smaller the value of the guidance scale parameter is, the more natural and real the image is, but the association relationship with the prompt may be lower.

In generating an image, the model may perform unconditional inference and conditional inference in order to generate unconditional predicted images and conditional predicted images (i.e., images generated with a given prompt), respectively. The final generation result is determined by fusing the unconditional predicted image and the conditional predicted image. In this case, the guidance scale parameter controls the strength of the fusion. Specifically, the final generated image=unconditional predicted image+w×(conditional predicted image−unconditional predicted image), and w represents the guidance scale parameter. Generally, a specific value of the guidance scale parameter may be set, for example, in a range of 1 to 10 (or another range). Typical values are usually set between 7 and 10, which allows for a better fit to a given condition while maintaining the naturality of the image. The guidance scale parameter is an important parameter of CFG, and by adjusting the value of the parameter, a balance point can be found between the naturality of the generated image and the correlation with the prompt.

With the implementations of the present disclosure, individual steps are set their own guidance parameters by dividing the plurality of steps involved in the diffusion model into a first set of steps and a second set of steps. Different guidance parameters may result in different workloads. In this way, the workloads of individual steps of the diffusion model can be adjusted. Specifically, for the first set of steps which is earlier, a smaller guide parameter may be set, thereby ensuring that the knowledge of both conditional inference and unconditional inference can be learnt in the early inference stage of the diffusion model. Further, for the second set of steps which is later, the guidance parameter may be set to a larger value, so that the output image of the model better matches the prompt. In this way, the performance of the diffusion model can be improved while ensuring the performance and functionality of the diffusion model.

### Detailed Process of Image Generation

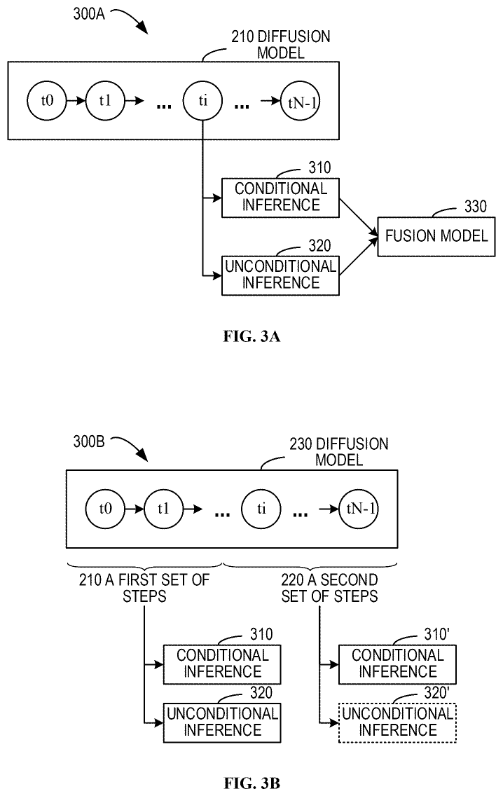

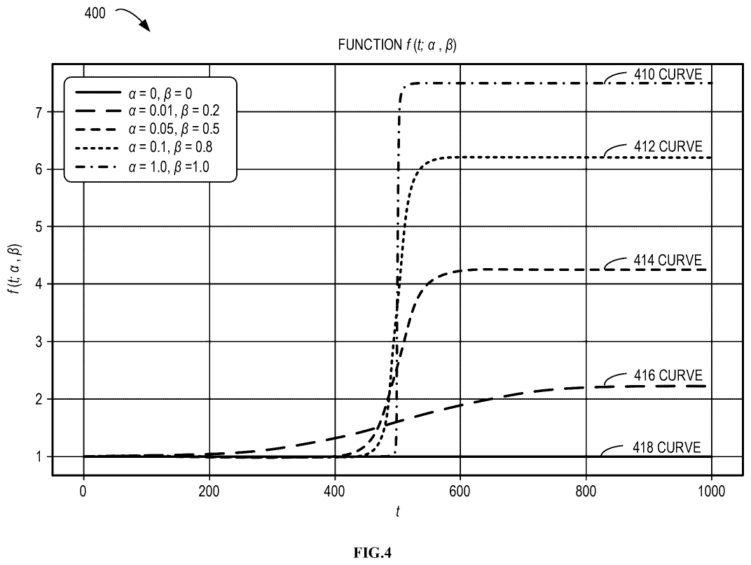

The overview of some implementations according to the present disclosure has been described, and more details regarding image generation will be described below. FIG. 3A illustrates a block diagram 300A for generating a fusion model according to some implementations of the present disclosure. As shown in FIG. 3A, for a particular step in a plurality of inference steps, at time instant tᵢ, the importance of conditional inference 310 and unconditional inference 320 may be adjusted by a guidance scale parameter. In this way, the fusion model 330 may achieve an expected balance between conditional inference and unconditional inference.

FIG. 3B illustrates a block diagram 300B for generating a fusion model according to some implementations of the present disclosure. As shown in FIG. 3B, a plurality of steps may be divided into a first set of steps 210 and a second set of steps 220. Specifically, the first set of steps and the second set of steps may be determined based on a predetermined division parameter. For example, based on the time order, one or more earlier steps in the inference process may be divided into a first stage, and one or more later steps in the inference process may be divided into a second stage, thereby determining the first set of steps and the second set of steps. Based on the number of the plurality of steps and the predetermined division parameter, a set of warm-up steps in the beginning phase of the plurality of steps may be determined. Further, the first set of steps may be determined based on the set of warm-up steps, and the second set of steps may be determined based on steps other than the set of warm-up steps in the plurality of steps.

According to some implementations of the present disclosure, the first set of steps includes at least one earlier step in the inference stage, and the second set of steps includes at least one later step in the inference stage. For example, the first set of steps may include step 0 to step k_{T′}−1 (corresponding to time instants t₀−(T′−1), respectively), and the second set of steps may include step k_{T′} to step N−1 (corresponding to time instants T′−t_{N-1}, respectively). The predetermined division parameter may specify the number of warm-up steps, or the proportion of the warm-up steps among the plurality of steps, and so on. Assuming that there are 1000 steps and the number of warm-up steps is 500 (or the warm-up steps account for 1/2 of all the steps). In this case, the first set of steps may include step 0 to step 499, and the second set of steps may include step 500 to step 999.

It should be understood that since the first set of steps involves denoising with a relatively coarser granularity, and the second set of steps involves denoising with a finer granularity, the first set of steps determines a distribution of content in the image, and thus has a higher importance in the inference process and more affects the content of the output image. In this case, conditional inference 310 and unconditional inference 320 may be performed in the first set of steps in order to improve the generalization capability of the model. Further, conditional inference 310′ may be performed in the second set of steps, and the unconditional inference 320′ may be omitted or the weight of the unconditional inference 320′ may be reduced in order to reduce the overall workload of the inference process.

According to some implementations of the present disclosure, the guidance parameter may be a classifier-free guidance parameter of the diffusion model. The guidance parameter may include a first guidance parameter and a second guidance parameter for distilling the diffusion model into the target model. In the application environment of knowledge distillation, the first guidance parameter may represent the CFG parameter of a student model (which corresponds to the target model), and the second guidance parameter may represent the CFG parameter of a teacher model (which corresponds to the diffusion model). Specifically, in the process of determining the guidance parameter, the first guidance parameter may be set to remain unchanged during the plurality of steps. Further, the second guidance parameter may be set based on the current step, the first set of steps, and the second set of steps, and the second guidance parameter varies with a position of the current step in the plurality of steps.

According to some implementations of the present disclosure, a distillation method is provided. Assuming that the distillation model includes a plurality of time instants 0−T, the output of the original diffusion model may be learned within a range [0, T′), and the distillation may be performed within a range [T′, T]. That is, the trained model is consistent with the original diffusion model as much as possible within the range [0, T′), and performs CFG inference in this range, thus preserving the early inference of the original model that has the maximum influence on the final generated image. And within the range [T′, T], the model only uses the forward inference once, thereby saving inference overheads.

According to some implementations of the present disclosure, the first guidance parameter includes a classifier-free guidance parameter associated with the diffusion model, and the second guidance parameter includes a classifier-free guidance parameter associated with the target model. Specifically, the CFG parameter may be determined specifically based on the position of the current time instant in the whole inference process. In this way, the CFG can be used to control the workload at different stages on the basis of existing diffusion models and distillation technical solutions.

According to some implementations of the present disclosure, in the distillation process, the following parameter configuration may be used:

$${CFG}^{stu} ≡ 1 \qquad Formula 1$$

In the above formula, CFG^{stu} represents the guidance parameter of the student model, and the guidance parameter CFG^{stu} of the student model is always set to 1. According to some implementations of the present disclosure, in order to set the second guidance parameter, the second guidance parameter may be determined based on a position of the current step in the plurality of steps, and a predetermined guidance parameter of the diffusion model. Specifically, the second guidance parameter may be determined based on the following formula:

$${CFG}^{tea} = β ( w - 1 ) \cdot \frac{σ ( - α ( {T}^{′} - t ) ) - σ ( - α {T}^{′} )}{1 + ( w - 1 ) \cdot σ ( - α {T}^{′} )} + 1 \qquad Formula 2$$

In the above formula, the guiding parameter CFG^{tea} of the teacher model vary with the current inference step. Specifically, t represents a current step, w represents a default scale parameter of the diffusion model, σ may represent a predetermined function, and α,β represent adjustable hyperparameters, for example, α,β correspond to the first hyperparameter and the second hyperparameter, respectively.

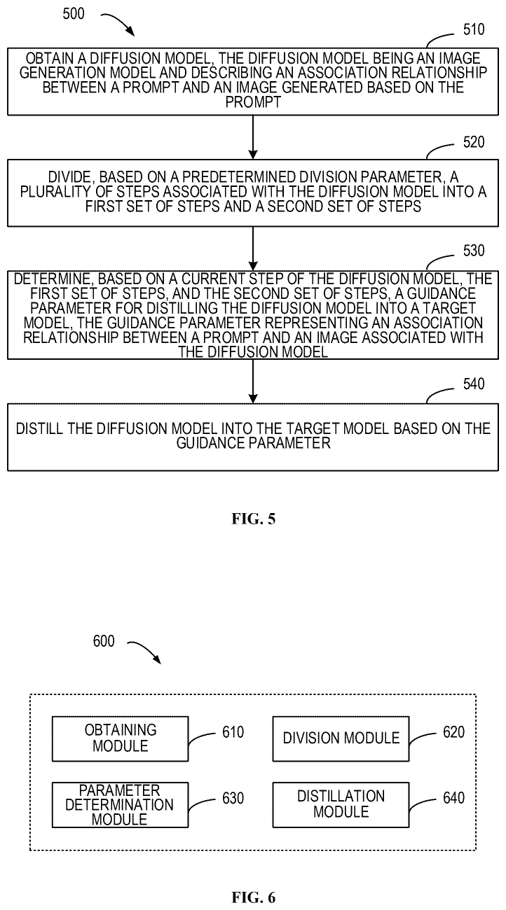

Further details are described with reference to FIG. 4, which illustrates a block diagram 400 of guidance parameters according to some implementations of the present disclosure. According to some implementations of the present disclosure, the first hyperparameter and the second hyperparameter may adjust a steep degree of CFG^{tea} curve. The first hyperparameter and the second hyperparameter may be set, and the two hyperparameters described above may have the same or different values. As shown in FIG. 4, curve 418 shows the case that α=0,β=0, in which the CFG^{tea} curve is relatively flat; curve 416 shows the case that α=0.01,β=0.2; curve 414 shows the case that α=0.05, β=0.5; curve 412 shows the case that α=0.1,β=0.8, and curve 410 shows the case that α=1.0,β=2.0. The steepness of the above curves increases successively

According to some implementations of the present disclosure, a first hyperparameter and a second hyperparameter may be determined based on the number of the plurality of steps and the number of the set of warm-up steps; and the second guidance parameter may be updated with the first hyperparameter and the second hyperparameter. Specifically, as the training progresses, the above parameters may be set as:

$$α = β = \frac{iter}{warmup\_iter} \qquad Formula 3$$

In the above formula, iter represents the current step, and warmup_iter represents a preset value. As the current step progresses, α,β gradually increase, and the curve gradually becomes steeper, and approaches the final optimization goal: degerming a segmentable CFG. It should be understood that FIG. 4 illustrates CFG^{tea} curve only with T′=500 as an example. CFG^{tea} curve may have a different shape when T′ is set to other values. Assuming that T′=300, then the curve will rise at about t=300, and at that point, the workload of the fusion model will be lower.

According to some implementations of the present disclosure, the predetermined guidance parameter is determined based on a predetermined scale parameter of the diffusion model. It should be understood that different models may have different default scale parameters, and the performance of the model is higher in a case where the scale parameter is set to the default scale parameter. In this way, the performance of the model may be further improved.

According to some implementations of the present disclosure, the target model includes at least one of the following: a full-volume image generation model, a low-rank adaptation plug-in model of a full-volume image generation model. Specifically, in the distillation process, the full-volume image generation model may be trained. It should be understood that a plurality of training samples may be utilized to determine the target model. The training samples match the input data of the distillation model. The images in the training samples may be represented as a matrix of a dimension of ch*width*hight. Here, ch represents the number of channels (e.g., ch=3 or has other values) in the image, and width represents the width of the image (e.g., width=1024 or has other values), and hight represents the height of the image (e.g., hight=1024 or has other values). The prompt portion in the training sample may include text expressed in natural language corresponding to the image content. Alternatively and/or additionally, in order to enable the model to obtain unconditional inference capabilities, the prompt may be set to null. A large number of training samples may be used to determine a corresponding loss function, and in turn to determine a target model including all network parameters.

Alternatively and/or additionally, the target model may be a plug-in of a full-volume image generation model, e.g., a low-rank adaptation plug-in. The plug-in may be used to fine-tune the large language model. The plug-in allows adapting to a new task or style by training a small, low-rank matrix without modifying the original model. The plug-in only requires less data and computing resources compared to retraining the entire model. For example, the plug-in may be applied to the framework of the diffusion model to generate an image with a particular style or to adjust the behavior of the model.

According to some implementations of the present disclosure, in response to determining that the target model is the low-rank adaptation plug-in model, the image generation model is updated with the low-rank adaptation plug-in model. Specifically, it is assumed that the image generation model can generate an image matching the prompt. The plug-in model may be trained with training data that includes a cartoon style, and the parameters of the image generation model may be fine-tuned with the plug-in model, so that the adjusted image generation model may generate a cartoon style image. Alternatively and/or additionally, the plug-in model may be trained with training data that includes a sketch style, and the parameters of the image generation model may be fine-tuned with the plug-in model, so that the adjusted image generation model may generate a sketch style image. With some implementations of the present disclosure, instead of retraining the entire image generation model, a plug-in model that achieves a desired goal can be obtained by using fewer training samples.

According to some implementations of the present disclosure, a target prompt is inputted to the target model, and the target prompt is represented in a natural language; and an output result based on the target prompt is received from the target model. After the target model has been obtained, a prompt may be input to the target model. After receiving the prompt, during the inference process, the target model may perform conditional inference and unconditional inference in a first stage (e.g., the first 500 steps in the above example), and perform only conditional inference in a second stage (e.g., the last 500 steps). In this way, the workload of the inference stage can be greatly reduced, thereby improving the inference efficiency.

According to some implementations of the present disclosure, a CFG with negative guidance capability is further proposed. On the basis of the existing diffusion model, a negative condition may be added: p_{θ}(x|not \tilde{c}, c₁, . . . , cₙ). For the negative condition, p_{θ}(x|not \tilde{c}) is expected to be sufficiently small, in which case it may be define that:

$${p}_{θ} ( x \vert not \tilde{c} , {c}_{1} ) ∝ \frac{{p}_{θ} ( x \vert {c}_{1} )}{{{p}_{θ} ( x \vert \tilde{c} )}^{α}} .$$

Specifically, the strength of the negative condition may be controlled with α. And in this case, it may be determined that:

$${p}_{θ} ( x \vert not \tilde{c} , {c}_{1} , … , {c}_{n} ) ∝ {p}_{θ} ( x ) \frac{{{p}_{θ} ( x )}^{α}}{{{p}_{θ} ( x \vert \tilde{c} )}^{α}} {\prod }_{i = 1}^{n} \frac{{p}_{θ} ( x \vert {c}_{i} )}{{p}_{θ} ( x )} .$$

The corresponding noise predictor may be represented as:

$${ϵ}_{θ}^{★} ( {x}_{t} , c , t ) = {ϵ}_{θ} ( {x}_{t} , t ) + {\sum }_{i = 1}^{n} {s}_{i} \cdot ( {ϵ}_{θ} ( {x}_{t} , {c}_{i} , t ) - {ϵ}_{θ} ( {x}_{t} , t ) ) - {s}_{neg} \cdot ( {ϵ}_{θ} ( {x}_{t} , \tilde{c} , t ) - {ϵ}_{θ} ( {x}_{t} , t ) ) .$$

According to some implementations of the present disclosure, n=1, s₁=w+1, s_{neg}=w, and in which case, it may be determined that:

$${ϵ}_{θ}^{★} ( {x}_{t} , c , t ) = ( w + 1 ) {ϵ}_{θ} ( {x}_{t} , {c}_{1} , t ) - w {ϵ}_{θ} ( {x}_{t} , \tilde{c} , t ) .$$

Specifically, it may be set that: scale=w, when scale is set to 1, it indicates that the prompt has a positive meaning; and when scale is set to 0, it indicates that the prompt has a negative meaning.

With the implementations of the present disclosure, individual steps are set their own guidance parameters by dividing the plurality of steps involved in the diffusion model into a first set of steps and a second set of steps. Different guidance parameters may result in different workloads. In this way, the workloads of individual steps of the diffusion model can be adjusted. Specifically, for the first set of steps which is earlier, a smaller guidance parameter may be set, thereby ensuring that the knowledge of both conditional inference and unconditional inference can be learnt in the early inference stage of the diffusion model. Further, the target model may support positive and negative inputs.

### Example Processes

FIG. 5 illustrates a flowchart of a method 500 for image generation according to some implementations of the present disclosure. At block 510, a diffusion model is obtained, the diffusion model is an image generation model and describes an association relationship between a prompt and an image generated based on the prompt; at block 520, based on a predetermined division parameter, a plurality of steps associated with the diffusion model are divided into a first set of steps and a second set of steps; at block 530, based on a current step of the diffusion model, the first set of steps, and the second set of steps, a guidance parameter for distilling the diffusion model into a target model is determined, the guidance parameter represents an association relationship between a prompt and an image associated with the diffusion model; and at block 540, the diffusion model is distilled into the target model based on the guidance parameter.

According to some implementations of the present disclosure, dividing, based on the predetermined division parameter, the plurality of steps into the first set of steps and the second set of steps includes: determining, based on the number of the plurality of steps and the predetermined division parameter, a set of warm-up steps in the plurality of steps; determining the first set of steps based on the set of warm-up steps; and determining the second set of steps based on a step other than the set of warm-up steps in the plurality of steps.

According to some implementations of the present disclosure, the guidance parameter includes a classifier-free guidance parameter of the diffusion model, the guidance parameter includes a first guidance parameter and a second guidance parameter for distilling the diffusion model into the target model, and determining the guidance parameter includes: setting the first guidance parameter to remain unchanged during the plurality of steps; and setting the second guidance parameter based on the current step, the first set of steps, and the second set of steps, the second guidance parameter varying with a position of the current step in the plurality of steps.

According to some implementations of the present disclosure, setting the second guidance parameter includes: determining the second guidance parameter based on the position of the current step in the plurality of steps, and a predetermined guidance parameter of the diffusion model.

According to some implementations of the present disclosure, it further includes: determining a first hyperparameter and a second hyperparameter based on the number of the plurality of steps and the number of the set of warm-up steps; and updating the second guidance parameter with the first hyperparameter and the second hyperparameter.

According to some implementations of the present disclosure, the predetermined guidance parameter is determined based on a predetermined scale parameter of the diffusion model.

According to some implementations of the present disclosure, the first guidance parameter includes a classifier-free guidance parameter associated with the diffusion model, and the second guidance parameter includes a classifier-free guidance parameter associated with the target model.

According to some implementations of the present disclosure, the target model includes at least one of the following: a full-volume image generation model, a low-rank adaptation plug-in model of a full-volume image generation model.

According to some implementations of the present disclosure, the method further includes: updating, in response to determining that the target model is the low-rank adaptation plug-in model, the image generation model with the low-rank adaptation plug-in model.

According to some implementations of the present disclosure, the method further includes: inputting a target prompt to the target model, the target prompt being represented in a natural language; and receiving an output result based on the target prompt from the target model.

### Example Apparatus and Device

FIG. 6 illustrates a block diagram of an apparatus 600 for image generation according to some implementations of the present disclosure. The apparatus includes: an obtaining module 610 configured to obtain a diffusion model, the diffusion model being an image generation model and describes an association relationship between a prompt and an image generated based on the prompt; a division module 620 configured to divide, based on a predetermined division parameter, a plurality of steps associated with the diffusion model into a first set of steps and a second set of steps; a parameter determination module 630 configured to determine, based on a current step of the diffusion model, the first set of steps, and the second set of steps, a guidance parameter for distilling the diffusion model into a target model, the guidance parameter representing an association relationship between a prompt and an image associated with the diffusion model; and a distillation module 640 configured to distill the diffusion model into the target model based on the guidance parameter.

According to some implementations of the present disclosure, the division module 620 is further configured to include: determining, based on the number of the plurality of steps and the predetermined division parameter, a set of warm-up steps in the plurality of steps; determining the first set of steps based on the set of warm-up steps; and determining the second set of steps based on a step other than the set of warm-up steps in the plurality of steps.

According to some implementations of the present disclosure, the guidance parameter includes a classifier-free guidance parameter of the diffusion model, the guidance parameter includes a first guidance parameter and a second guidance parameter for distilling the diffusion model into the target model, and the parameter determination module 630 is further configured to: set the first guidance parameter to remain unchanged during the plurality of steps; and set the second guidance parameter based on the current step, the first set of steps, and the second set of steps, the second guidance parameter varying with a position of the current step in the plurality of steps.

According to some implementations of the present disclosure, the parameter determination module 630 is further configured to determine the second guidance parameter based on the position of the current step in the plurality of steps, and a predetermined guidance parameter of the diffusion model.

According to some implementations of the present disclosure, the parameter determination module 630 is further configured to: determine a first hyperparameter and a second hyperparameter based on the number of the plurality of steps and the number of the set of warm-up steps; and update the second guidance parameter with the first hyperparameter and the second hyperparameter.

According to some implementations of the present disclosure, the predetermined guidance parameter is determined based on a predetermined scale parameter of the diffusion model.

According to some implementations of the present disclosure, the first guidance parameter includes a classifier-free guidance parameter associated with the diffusion model, and the second guidance parameter includes a classifier-free guidance parameter associated with the target model.

According to some implementations of the present disclosure, the target model includes at least one of the following: a full-volume image generation model, a low-rank adaptation plug-in model of a full-volume image generation model.

According to some implementations of the present disclosure, the apparatus 600 further includes: an updating module, configured to update, in response to determining that the target model is the low-rank adaptation plug-in model, the image generation model with the low-rank adaptation plug-in model.

According to some implementations of the present disclosure, the apparatus 600 further includes: a processing module, configured to input a target prompt to the target model, the target prompt being represented in a natural language; and receive an output result based on the target prompt from the target model.

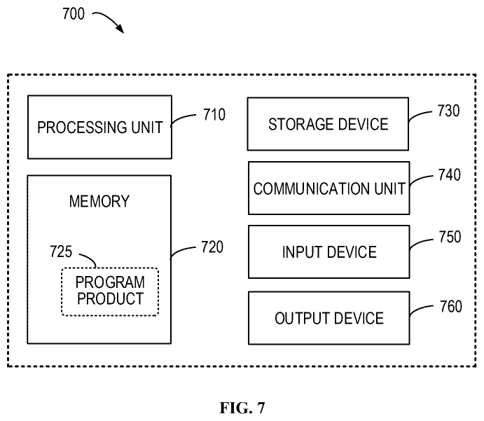

FIG. 7 illustrates a block diagram of a device 700 capable of implementing various implementations of the present disclosure. It should be understood that the computing device 700 shown in FIG. 7 is merely illustrative and should not constitute any limitation on the function and scope of the implementations described herein. The computing device 700 shown in FIG. 7 may be configured to implement the method described above.

As shown in FIG. 7, the computing device 700 is in the form of a general-purpose computing device. Components of the computing device 700 may include, but are not limited to, one or more processors or processing units 710, a memory 720, a storage device 730, one or more communication units 740, one or more input devices 750, and one or more output devices 760. The processing unit 710 may be an actual or virtual processor and capable of performing various processes according to programs stored in the memory 720. In multiprocessor systems, multiple processing units execute computer-executable instructions in parallel to improve parallel processing capabilities of computing device 700.

The computing device 700 typically includes a plurality of computer storage media. Such media may be any available media accessible by the computing device 700, including, but not limited to, volatile and non-volatile media, removable and non-removable media. The memory 720 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 730 may be a removable or non-removable medium and may include a machine-readable medium, such as a flash drive, magnetic disk, or any other medium, which may be capable of storing information and/or data (for example, the training data for training) and may be accessed within computing device 700.

The computing device 700 may further include additional removable/non-removable, volatile/non-volatile storage media. Although not shown in FIG. 7, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 720 may include a computer program product 725 having one or more program modules configured to perform various methods or actions of various implementations of the disclosure.

The communications unit 740 implements communications with other computing devices over a communications medium. Additionally, the functionality of components of the computing device 700 may be implemented in a single computing cluster or multiple computing machines capable of communicating over a communication connection. Thus, the computing device 700 may operate in a networked environment using logical connections with one or more other servers, network personal computers (PCs), or another network node.

The input device 750 may be one or more input devices, such as a mouse, a keyboard, a trackball, or the like. The output device 760 may be one or more output devices, such as a display, a speaker, a printer, or the like. The computing device 700 may also communicate with one or more external devices (not shown) through the communication unit 740 as needed, external devices such as storage devices, display devices, etc., communicate with one or more devices that enable a user to interact with the computing device 700, or communicate with any device (e.g., a network card, a modem, etc.) that enables the computing device 700 to communicate with one or more other computing device s. Such communication may be performed via an input/output (I/O) interface (not shown).

According to implementations of the present disclosure, there is provided a computer-readable storage medium having computer-executable instructions stored thereon, wherein the computer-executable instructions are executed by a processor to implement the method described above. According to implementations of the disclosure, a computer program product is further provided, the computer program product being tangibly stored on a non-transitory computer-readable medium and including computer-executable instructions, the computer-executable instructions being executed by a processor to implement the method described above. According to an implementation of the present disclosure, a computer program product is provided, the computer program product having a computer program stored thereon, the computer program, when executed by a processor, causing the processor to implement the foregoing method.

Aspects of the disclosure are described herein with reference to flowcharts and/or block diagrams of methods, apparatuses, devices, and computer program products implemented in accordance with the disclosure. It should be understood that each block of the flowchart and/or block diagram, and combinations of blocks in the flowcharts and/or block diagrams, may be implemented by computer-readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce apparatus to implement the functions/acts specified in the flowchart and/or block(s) in block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block(s) in block diagram.

The computer-readable program instructions may be loaded onto a computer, other programmable data processing apparatus, or other devices, such that a series of operational steps are performed on a computer, other programmable data processing apparatus, or other devices to produce a computer-implemented process such that the instructions executed on a computer, other programmable data processing apparatus, or other devices implement the functions/acts specified in the flowchart and/or block(s) in block diagram.

The flowchart and block diagrams in the figures show architecture, functionality, and operation of possible implementations of systems, methods, and computer program products according to various implementations of the disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, the practical application, or improvements to the technology in the marketplace, or to enable others of ordinary skill in the art to understand the various implementations disclosed herein.

1. A method for image generation, comprising:
obtaining a diffusion model, wherein the diffusion model is an image generation model and describes an association relationship between a prompt and an image generated based on the prompt;
dividing, based on a predetermined division parameter, a plurality of steps associated with the diffusion model into a first set of steps and a second set of steps;
determining, based on a current step of the diffusion model, the first set of steps, and the second set of steps, a guidance parameter for distilling the diffusion model into a target model, the guidance parameter representing an association relationship between a prompt and an image associated with the diffusion model; and
distilling the diffusion model into the target model based on the guidance parameter.

2. The method of claim 1, wherein dividing, based on the predetermined division parameter, the plurality of steps into the first set of steps and the second set of steps comprises:
determining, based on the number of the plurality of steps and the predetermined division parameter, a set of warm-up steps in the plurality of steps;
determining the first set of steps based on the set of warm-up steps; and
determining the second set of steps based on a step other than the set of warm-up steps in the plurality of steps.

3. The method of claim 1, wherein the guidance parameter comprises a classifier-free guidance parameter of the diffusion model, the guidance parameter comprises a first guidance parameter and a second guidance parameter for distilling the diffusion model into the target model, and determining the guidance parameter comprises:
setting the first guidance parameter to remain unchanged during the plurality of steps; and
setting the second guidance parameter based on the current step, the first set of steps, and the second set of steps, the second guidance parameter varying with a position of the current step in the plurality of steps.

4. The method of claim 3, wherein setting the second guidance parameter comprises: determining the second guidance parameter based on the position of the current step in the plurality of steps, and a predetermined guidance parameter of the diffusion model.

5. The method of claim 4, further comprising:
determining a first hyperparameter and a second hyperparameter based on the number of the plurality of steps and the number of the set of warm-up steps; and
updating the second guidance parameter with the first hyperparameter and the second hyperparameter.

6. The method of claim 4, wherein the predetermined guidance parameter is determined based on a predetermined scale parameter of the diffusion model.

7. The method of claim 3, wherein the first guidance parameter comprises a classifier-free guidance parameter associated with the diffusion model, and the second guidance parameter comprises a classifier-free guidance parameter associated with the target model.

8. The method of claim 1, wherein the target model comprises at least one of the following: a full-volume image generation model, a low-rank adaptation plug-in model of a full-volume image generation model.

9. The method of claim 8, further comprising: updating, in response to determining that the target model is the low-rank adaptation plug-in model, the image generation model with the low-rank adaptation plug-in model.

10. The method of claim 1, further comprising:
inputting a target prompt to the target model, wherein the target prompt is represented in a natural language; and
receiving an output result based on the target prompt from the target model.

11. An electronic device, comprising:
at least one processor; and
at least one memory coupled to the at least one processor and storing instructions for execution by the at least one processor, the instructions, when executed by the at least one processor, causing the electronic device to perform acts comprising:
obtaining a diffusion model, wherein the diffusion model is an image generation model and describes an association relationship between a prompt and an image generated based on the prompt;
dividing, based on a predetermined division parameter, a plurality of steps associated with the diffusion model into a first set of steps and a second set of steps;
determining, based on a current step of the diffusion model, the first set of steps, and the second set of steps, a guidance parameter for distilling the diffusion model into a target model, the guidance parameter representing an association relationship between a prompt and an image associated with the diffusion model; and
distilling the diffusion model into the target model based on the guidance parameter.

12. The electronic device of claim 11, wherein dividing, based on the predetermined division parameter, the plurality of steps into the first set of steps and the second set of steps comprises:
determining, based on the number of the plurality of steps and the predetermined division parameter, a set of warm-up steps in the plurality of steps;
determining the first set of steps based on the set of warm-up steps; and
determining the second set of steps based on a step other than the set of warm-up steps in the plurality of steps.

13. The electronic device of claim 11, wherein the guidance parameter comprises a classifier-free guidance parameter of the diffusion model, the guidance parameter comprises a first guidance parameter and a second guidance parameter for distilling the diffusion model into the target model, and determining the guidance parameter comprises:
setting the first guidance parameter to remain unchanged during the plurality of steps; and
setting the second guidance parameter based on the current step, the first set of steps, and the second set of steps, the second guidance parameter varying with a position of the current step in the plurality of steps.

14. The electronic device of claim 13, wherein setting the second guidance parameter comprises: determining the second guidance parameter based on the position of the current step in the plurality of steps, and a predetermined guidance parameter of the diffusion model.

15. The electronic device of claim 14, wherein the acts further comprise:
determining a first hyperparameter and a second hyperparameter based on the number of the plurality of steps and the number of the set of warm-up steps; and
updating the second guidance parameter with the first hyperparameter and the second hyperparameter.

16. The electronic device of claim 14, wherein the predetermined guidance parameter is determined based on a predetermined scale parameter of the diffusion model.

17. The electronic device of claim 13, wherein the first guidance parameter comprises a classifier-free guidance parameter associated with the diffusion model, and the second guidance parameter comprises a classifier-free guidance parameter associated with the target model.

18. The electronic device of claim 11, wherein the target model comprises at least one of the following: a full-volume image generation model, a low-rank adaptation plug-in model of a full-volume image generation model.

19. The electronic device of claim 18, wherein the acts further comprise: updating, in response to determining that the target model is the low-rank adaptation plug-in model, the image generation model with the low-rank adaptation plug-in model.

20. A non-transitory computer-readable storage medium having a computer program stored thereon, the computer program, when executed by a processor, causing the processor to perform acts comprising:
obtaining a diffusion model, wherein the diffusion model is an image generation model and describes an association relationship between a prompt and an image generated based on the prompt;
dividing, based on a predetermined division parameter, a plurality of steps associated with the diffusion model into a first set of steps and a second set of steps;
determining, based on a current step of the diffusion model, the first set of steps, and the second set of steps, a guidance parameter for distilling the diffusion model into a target model, the guidance parameter representing an association relationship between a prompt and an image associated with the diffusion model; and
distilling the diffusion model into the target model based on the guidance parameter.
